(19) United States
(12) Patent Application Publication
(10) Pub. No.: US 2017/0170584 A1
(43) Pub. Date: Jun. 15, 2017

(54) SIM CARD SLOT AND SIM CARD TRAY AND ELECTRONIC PRODUCT

(71) Applicants: LE HOLDINGS (BEIJING) CO., LTD., Beijing (CN); LEMOBILE INFORMATION TECHNOLOGY (BEIJING) CO., LTD, Beijing (CN)

(72) Inventor: Zengkui YANG, Beijing (CN)

(21) Appl. No.: 15/235,795

(22) Filed: Aug. 12, 2016

Related U.S. Application Data
(63) Continuation of application No. PCT/CN2016/088470, filed on Jul. 4, 2016.

(30) Foreign Application Priority Data
Dec. 14, 2015 (CN) 2015210375704

(51) Int. Cl. H01R 12/72

(52) U.S. Cl. CPC H01R 12/72

(57) ABSTRACT

The present invention relates to a SIM card slot, a SIM card tray and an electronic device, wherein the said SIM card slot comprises a slot and at least one stopper, wherein the said stopper is configured on the inner side of the said slot, and the said stopper blocks part of the said slot.

### CROSS REFERENCE TO RELATED APPLICATIONS

This application is a continuation of International Application No. PCT/CN2016/088470, filed on Jul. 4, 2016, which is based upon and claims priority to Chinese Patent Application No. 2015210375704, filed on Dec. 14, 2015, the entire contents of which are incorporated herein by reference.

### TECHNICAL FIELD

The present invention relates to the technological field of electronics, and more particularly, to a SIM card slot, a SIM card tray and an electronic device.

### BACKGROUND

Most recent designs of smart phones follow systemic design principles. The SIM card tray design, by which users are simply required to push the tray into the phone following placing a SIM card into the tray, is widely adopted in mobile phones. However, the tray sits within a phone body by only exposing the slot, and the structure of such a tray is considered to be slim and simple. As such, it becomes difficult for users to determine, by looking at the slot, the correct orientation to which the tray should be inserted into the slot. Many users, in practice, place a SIM card tray up-side-down and reversely insert it into the SIM card slot. If reverse insertion was conducted by a great force, it would easily break any structure inside the SIM card slot such as, for example: an elastic connection plate, and consequently damage the function of SIM card recognition of that mobile phone.

Therefore, there is need for improvement of the structure of a SIM card tray or a SIM card slot of a mobile phone. It is to avoid damage of the slot caused by inserting a SIM card tray up-side-down, or to help users with recognizing the correct orientation to insert a SIM card tray.

### SUMMARY

One object of embodiments of the present invention is to avoid the up-side-down insertion of a SIM card tray into a SIM card slot.

In one aspect of the present invention, it is provided a SIM card slot comprising a slot and at least one stopper, wherein the said stopper is configured on the inner side of the said slot, and the said stopper blocks part of the said slot.

Optionally, the said slot comprises a first side strip, a second side strip and two side walls.

Optionally the said stopper is configured on the inner side of the said first or second side strip.

Or, optionally, the said stopper is configured on the inner side of one of the said side walls.

Optionally, the said stopper is configured on the inner side of the said first or second side strip and it is configured on the inner side of one of the said side walls.

Optionally, the said SIM card slot comprises two stoppers.

Embodiments of the present invention further provides an SIM card tray, wherein the said SIM card tray comprises a front end on which an upper stopper is formed.

Optionally, the said SIM card tray comprises two lateral edges, a bottom frame is configured on the ends of the said lateral edges, and the said bottom frame is the said upper stopper.

Embodiments of the present invention further provides an electronic device, wherein it comprises:

an electronic device body, wherein the said SIM card slot, according to embodiments of the present invention, is configured on a side of the said electronic device body, and inner side of the said slot is inside the said electronic device body.

The said SIM card tray according to embodiments of the present invention is inserted into the said SIM card slot.

The technical effect of embodiments of the present invention lies in that the stopper can stop the SIM card tray from being inserted into the SIM card slot when it is inserted up-side-down, so as to prevent the SIM card tray from damaging the structure within the SIM card slot.

The nature and other advantages of the present invention will become more apparent upon consideration of the following detailed description, taken in conjunction with the accompanying figures.

### BRIEF DESCRIPTION OF THE DRAWINGS

One or more embodiments is/are accompanied by the following figures for illustrative purposes and serve to only to provide examples. These illustrative descriptions in no way limit any embodiments. Similar elements in the figures are denoted by identical reference numbers. Unless it states the otherwise, it should be understood that the drawings are not necessarily proportional or to scale.

FIG. 1 is an illustrative structural view of a SIM card slot in accordance with some embodiments of the present invention;

FIG. 2 is an enlarged structural view of a SIM card slot in accordance with some embodiments of the present invention;

FIG. 3 is an illustrative structural view of a SIM card tray in accordance with some embodiments of the present invention;

FIG. 4 is an illustrative structural view of a SIM card tray in accordance with some embodiments of the present invention;

FIG. 5 is an exploded structural view of an electronic device in accordance with some embodiments of the present invention; and

FIG. 6 is an exploded structural view of an electronic device in accordance with some embodiments of the present invention.

### DETAILED DESCRIPTION

Embodiments of the present invention are to be further elaborated in detail with reference to the accompanying figures. It should be noted that, unless specifically stated otherwise, components and procedures of corresponding arrangements, numerical expressions and values disclosed do not limit the scope of the present invention.

At least one of the following embodiments is, in fact, merely for the purpose of illustration, which is not intended as any limitation upon the present invention and implementation or application of the same.

Technology and apparatus known to those skilled in the art will not to be discussed in detail. The said technology and apparatus should, however, under some circumstances, where it is appropriate, be considered as part of the present disclosure.

In all examples shown and discussed herein, any specific value should be interpreted merely as an illustration rather than a limitation. Accordingly, other examples of embodiments can choose different values.

The present invention provides a SIM card slot, wherein it comprises a slot and at least one stopper, the said stopper is configured on the inner side of the said slot, where the inner side of the said slot refers to a side into which the slot extends. The said stopper blocks part of the said slot. The said stopper is configured inside the slot and may extend, by a certain length of distance, from the edge of the slot towards the centre of the slot. As such, the stopper can block part of the slot when viewing from a point facing towards the slot, namely on the cross-sectional surface of the slot.

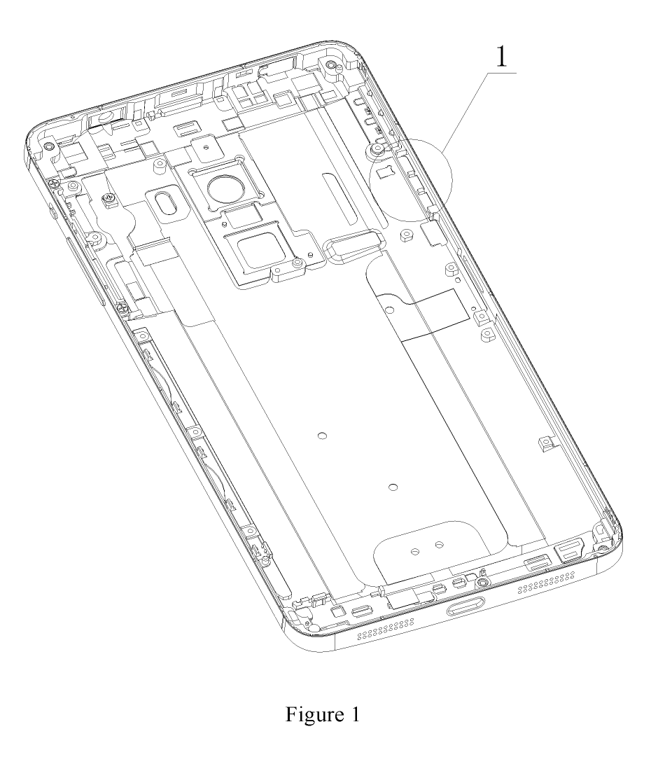

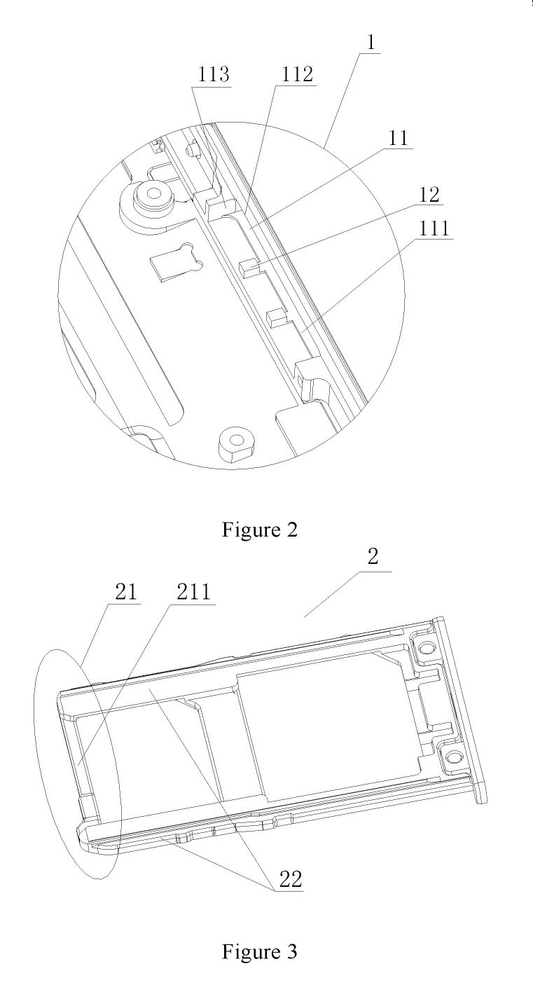

For example, FIGS. 1-2 illustrate an embodiment of the present invention. The said SIM card slot 1 is configured inside an electronic device, where a slot 11 is on the side walls 113 of the electronic device. The said slot 11 is roughly of a rectangular shape, wherein it comprises a first side strip 111, a second side strip 112 and two side walls 113, the first side strip 111 and the second side strip 112 are two relatively long edges, and the two side walls 113 respectively connect to the first side strip 111 and the second side strip 112. Length of the first side strip 111 and the second side strip 112 is approximately the same as the width of a SIM card or a SIM card tray. Height of the two side walls 113 is approximately the same as the thickness of a SIM card or a SIM card tray. Optionally, in this embodiment, the said stopper 12 is configured on the inner side of the said first side strip 111, and extends from the said first side strip 111 upward by a certain length of distance. The said stopper 12 blocks part of the slot 11 that a preventive structure against up-side-down insertion of the tray is consequently formed inside the slot 11. Accordingly, the tray associated with the slot of embodiments of the present invention is also configured with a preventive structure against the up-side-down insertion of the tray. When the tray is inserted into the slot 1 with the correct orientation, preventive structures against the up-side-down insertion of the slot 11 and the tray will not intersect, such that the tray can be fully inserted into the slot 1. If the tray was however inserted, against the correct orientation, into the slot 1, the stopper 12 at the said slot 11 would make contact with the preventive structure against the up-side-down insertion on the tray, preventing the tray from further insertion. The SIM card slot 1 provided by embodiments of the present invention can effectively prevent a card tray from being inserted against the correct orientation into the slot 1, in order to prevent the card tray from causing damage to the structure within the slot 1.

Optionally, the said stopper 12 of embodiments of the present invention is not only limited by being configured on the inner side of the first side strip 111 as shown in FIGS. 1-2. In other embodiments of the present invention, the said stopper may also be configured in other positions, provided that part of the said slot is blocked. For example, the said stopper may also be configured on the inner side of the said second side strip, or on the inner side of one of the said side walls.

Particularly, the said stopper 12 provided in embodiments of the present invention further acts, to some extent, as a means for guiding the said tray into the said slot 1. For example, the said stopper 12 may be formed on the inner side of the said first side strip 111 and one of the said side walls 113, where there is no stopper 12 on the inner side of the said second side strip 112 and the other one of the said side walls 113. Consequently, when the tray is inserted, the stopper 12 can stably keep the tray in a proper position, so that it performs a function of guidance. Further, the stopper 12 under such an arrangement can better realize the function of prevention against the up-side-down insertion of the tray. Of course, those skilled in the art can also configure a stopper 12 on the inner side of the second side strip 112 and a side wall 113, but they usually do not configure stoppers 12 on all the inner sides of the first side strip 111, the second side strip 112 and one of the side walls 113 of the slot 11, because the tray would be difficult to be inserted by users under this approach even if it was correctly inserted.

Furthermore, in embodiments shown in FIGS. 1-2, two stoppers 12 are configured on the inner side of the first side strip 111, so as to avoid any inclination occurred when the SIM card tray is inserted up-side-down. Such inclination of the tray may also damage the structure.

Further, embodiments of the present invention provides a SIM card tray 2 which comprises a front end 21 for the purpose of introducing the tray 2 to be fully inserted into the slot. An upper stopper 211 is formed on the said front end 21, and the said upper stopper 211 is to work with the above mentioned stopper 12 in the hope of preventing the said tray 2 to be inserted up-side-down. Observing from the front of the said front end 21, it has the shape which is almost rectangular and can match the shape of the slot 11.

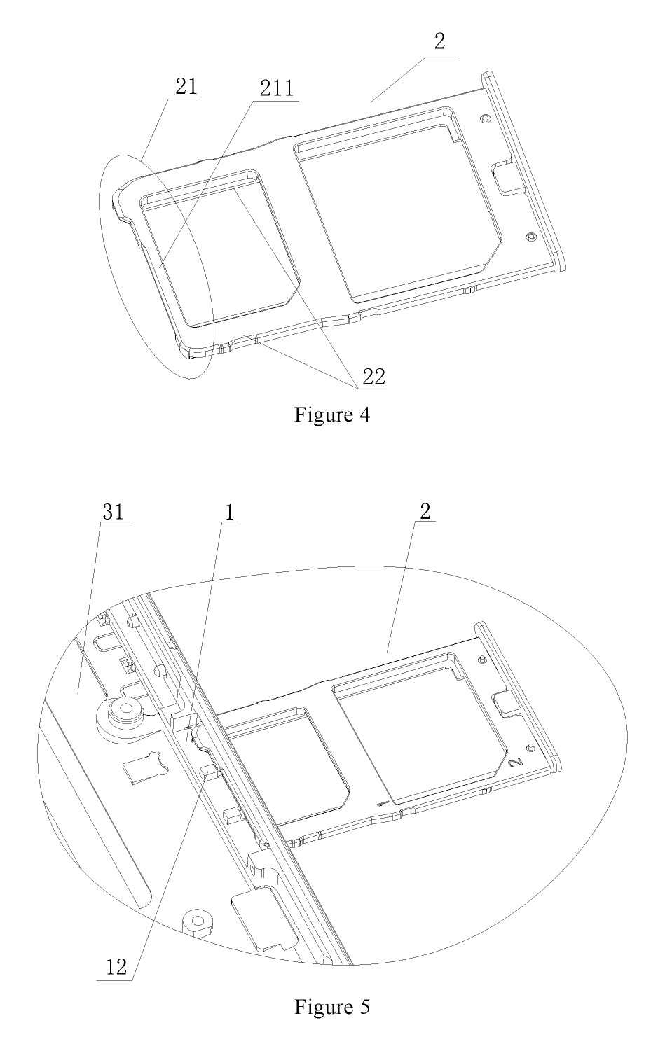

Specifically, as shown in FIGS. 3-4, the said SIM card tray 2 usually comprises two lateral edges 22, wherein a bottom frame which connects the said lateral edges 22 is configured on the ends of the said lateral edges 22, and the said bottom frame constitutes the said upper stopper 211. As shown in FIG. 3, the said bottom frame is laid under the entire tray 2, while, as shown in FIG. 4, the said bottom frame is laid above the entire tray 2. In this way, the said bottom frame avoids intersecting with the stopper 12 when the tray 2 is inserted with the correct orientation into the slot 11, while it would make contact with the stopper 12 and be prevented from further insertion when the tray 2 was inserted up-side-down into the slot 11.

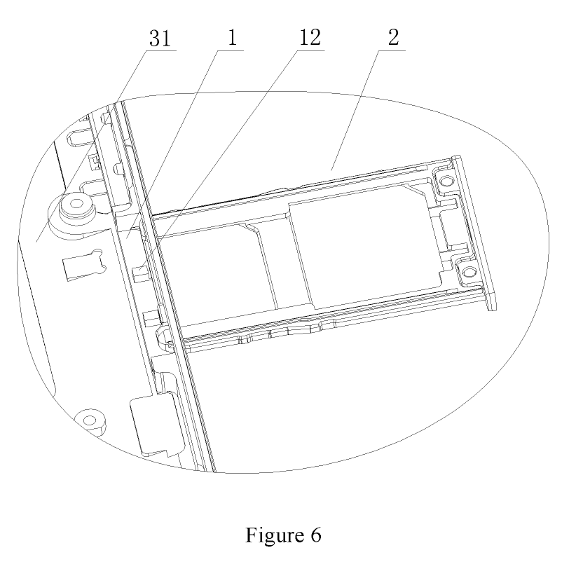

Embodiments of the present invention further provides an electronic device, wherein it comprises an electronic device body 31, a said SIM card slot 1 is configured on a side of the said electronic device body 31 as shown in FIG. 2, and inner side of the said slot 11 is inside the said electronic device body 31. Such electronic product further comprises, as shown in FIGS. 3-4, a SIM card tray 2 which is to be inserted into the said slot 1. FIG. 5 illustrates the insertion of the said tray 2 with the correct orientation. The bottom frame on the said front end avoids the said stopper 12, such that the said tray 2 is correctly inserted into the said slot 1. FIG. 6 illustrates the insertion of the said tray 2 with an up-side-down orientation. When it happens, the said bottom frame and the said stopper 12 are on the same side, the said bottom frame will intersect with the said stopper 12, such that further insertion of the said tray 2 is therefore prevented. In other embodiments of the present invention, the said stopper 12 can also be configured on the inner side of the second side strip 112 or on the inner side of side walls. The position of the said upper stopper 211 may also subsequently be varied, such that the said upper stopper 211 would make contact with the said stopper 12 when the said tray 2 was inserted up-side-down. The present invention places no restriction in relation to this sort of variations.

Embodiments of the present invention are elaborated in detail by examples, whereas those skilled in the art should appreciate that the above examples are merely for the purpose of illustration rather than limitation of the scope of the present invention. It should be further understood that changes can be made to those embodiments without deviating from the spirit and scope of the invention. The scope of the present invention is defined by the attached claims.

1-9. (canceled)

10. A SIM card slot, comprising a slot and at least one stopper, wherein the said stopper is configured on the inner side of the said slot, and the said stopper blocks part of the said slot.

11. The SIM card slot according to claim 10, wherein, the said slot comprises a first side strip, a second side strip and two side walls.

12. The SIM card slot according to claim 11, wherein, the said stopper is configured on the inner side of the said first or second side strip.

13. The SIM card slot according to claim 11, wherein, the said stopper is configured on the inner side of one of the said side walls.

14. The SIM card slot according to claim 11, wherein, the said stopper is configured on the inner side of the said first or second side strip, and is configured on the inner side of one of the said side walls.

15. The SIM card slot according to claim 10, wherein, the said SIM card slot comprises two stoppers.

16. A SIM card tray, the said SIM card tray comprises a front end on which an upper stopper is formed.

17. The SIM card tray according to claim 16, wherein, the said SIM card tray comprises two lateral edges, a bottom frame which connects the said lateral edges is configured on the ends of the said lateral edges, and the said bottom frame constitutes the said upper stopper.

18. An electronic device, comprising:
an electronic device body, wherein a SIM card slot and a SIM card tray are configured on a side of the said electronic device body,
wherein, the said SIM card slot comprises a slot and at least one stopper, the said stopper is configured on the inner side of the said slot, the said stopper blocks part of the said slot, and the inner side of the said slot is inside the said electronic device body;
the said SIM card tray comprises a front end on which an upper stopper is formed, and the said SIM card tray is inserted into the said SIM card slot.

19. An electronic device according to claim 18, wherein, the said slot comprises a first side strip, a second side strip and two side walls.

20. An electronic device according to claim 19, wherein, the said stopper is configured on the inner side of the said first or second side strip.

21. An electronic device according to claim 19, wherein, the said stopper is configured on the inner side of one of the said side walls.

22. An electronic device according to claim 19, wherein, the said stopper is configured on the inner side of the said first or second side strip, and is configured on the inner side of one of the said side walls.

23. An electronic device according to claim 18, wherein, the said SIM card slot comprises two stoppers.

24. An electronic device according to claim 18, wherein, the said SIM card tray comprises two lateral edges, a bottom frame which connects the said lateral edges is configured on the ends of the said lateral edges, and the said bottom frame constitutes the said upper stopper.
